(19) United States
(12) Patent Application Publication
(10) Pub. No.: US 2025/0334909 A1
(43) Pub. Date: Oct. 30, 2025

(54) ROTATING FIXING MEMBER, FIXING DEVICE, ELECTROPHOTOGRAPHIC IMAGE FORMING APPARATUS, METHOD OF MANUFACTURING ROTATING FIXING MEMBER, AND CONDUCTIVE MEMBER

(71) Applicant: CANON KABUSHIKI KAISHA, Tokyo (JP)

(72) Inventors: MIZUKI KAWABE, Kanagawa (JP); AKIRA OKANO, Kanagawa (JP); MATSUTAKA MAEDA, Kanagawa (JP); KOSEI HISADOME, Kanagawa (JP)

(21) Appl. No.: 19/187,276

(22) Filed: Apr. 23, 2025

(30) Foreign Application Priority Data
Apr. 24, 2024 (JP) 2024-070378
Feb. 19, 2025 (JP) 2025-025262

(51) Int. Cl. G03G 15/20

(52) U.S. Cl. CPC G03G 15/2057; G03G 15/2064; G03G 2215/2025

(57) ABSTRACT

A rotating fixing member containing a base material containing a resin, a heat generating layer on the base material, and a resin layer on a surface of the heat generating layer opposite to another surface of the heat generating layer facing the base material. The heat generating layer extends in a circumferential direction of an outer peripheral surface of the base material. The heat generating layer contains silver. At least one of the specific conditions (A) and (B) is satisfied: (A) silver sulfide is present at the surface of the heat generating layer opposite to the another surface facing the base material, (B) silver sulfide is present inside of the heat generating layer.

### BACKGROUND OF THE DISCLOSURE

### Field of the Disclosure

The present disclosure relates to a rotating fixing member used in a fixing device of an electrophotographic image forming apparatus such as an electrophotographic copying machine or a printer, a fixing device, an electrophotographic image forming apparatus, a method of manufacturing the rotating fixing member, and a conductive member.

### Description of the Related Art

A fixing device mounted in an electrophotographic image forming apparatus, such as an electrophotographic copying machine or a printer, generally fixes a toner image to a recording material by heating the recording material carrying an unfixed toner image at a nip portion, which is formed by a heated rotating fixing member and a pressure roller in contact with the rotating fixing member while conveying the recording material.

A fixing device of an electromagnetic induction heating system has been developed and put into practical use, the fixing device having a heat generating layer on a rotating fixing member and being able to directly heat the heat generating layer. The fixing device of the electromagnetic induction heating system has an advantage that a warm-up time is short.

The heat generating layer requires conductivity and durability against repeated strain under heating. For example, Japanese Patent Application Publication No. 2021-051136 discloses a fixing member having a heat generating layer formed by copper plating and having a predetermined pattern.

### SUMMARY OF THE DISCLOSURE

The inventors have an expectation of an effect of reducing uneven heat generation and have attempted to apply a silver nano-ink capable of controlling a fine line width and a space when forming a heat generating layer. The heat generating layer formed of a silver nano-ink has pores. The presence of the pores makes it possible to expect an improvement in durability by improving adhesion by an anchor effect when forming a resin layer such as a protective layer in contact with the heat generating layer.

On the other hand, in a rotating fixing member, there is a phenomenon that the temperature of a member increases at an end where paper does not pass, that is, a so-called paper non-passing portion. The rotating fixing member is heated to maintain a fixing temperature at any time in order to reliably fix toner at a paper passing portion through which paper passes. Since the paper passes through the paper passing portion while taking away heat, heating is continuously required. On the other hand, in the paper non-passing portion, there is no transfer of heat due to the passage of paper, and thus the temperature of the member may become higher than a set temperature. This phenomenon is likely to occur particularly under special use environments such as continuous printing on small-sized paper.

The inventors confirmed that, when a rotating fixing member using a silver nano-ink for manufacturing a heat generating layer is used, the resistance of the heat generating layer increases when a high temperature state above a set temperature continues for a long period of time in a paper non-passing portion. When the resistance increases in the paper non-passing portion of such small-sized paper, the amount of heat generation due to electromagnetic induction becomes uneven, and when fixing to larger-sized paper, the fixing properties at the end of the paper deteriorate.

The present disclosure relates to a rotating fixing member that is excellent in durability even in a printing environment where a high temperature state continues for a long time. The present disclosure also relates to a fixing device including the rotating fixing member and an electrophotographic image forming apparatus. The present disclosure also relates to a method of manufacturing the rotating fixing member. The present disclosure also relates to a conductive member capable of curbing an increase in resistance at high temperatures.

The present disclosure relates to a rotating fixing member including a base material containing a resin, a heat generating layer on the base material, and a resin layer on a surface of the heat generating layer opposite to another surface of the heat generating layer facing the base material, wherein the heat generating layer extends in a circumferential direction of an outer peripheral surface of the base material, the heat generating layer contains silver, and silver sulfide is present at the surface of the heat generating layer opposite to the another surface facing the base material.

The present disclosure also relates to a rotating fixing member including a base material containing a resin, a heat generating layer on the base material, and a resin layer on a surface of the heat generating layer opposite to another surface of the heat generating layer facing the base material. The heat generating layer extends in a circumferential direction of an outer peripheral surface of the base material, the heat generating layer contains silver, and silver sulfide is present inside of the heat generating layer.

The present disclosure also relates to a rotating fixing member including a base material containing a resin, a heat generating layer on the base material, and a resin layer on a surface of the heat generating layer opposite to another surface of the heat generating layer facing the base material. The heat generating layer extends in a circumferential direction of an outer peripheral surface of the base material, the heat generating layer contains silver, and at least one of the following conditions (A) and (B) is satisfied, (A): silver sulfide is present at the surface of the heat generating layer opposite to the another surface facing the base material, (B): silver sulfide is present inside of the heat generating layer.

The present disclosure also relates to a fixing device including the rotating fixing member mentioned above; and an induction heating device that causes the rotating fixing member to generate heat by induction heating.

The present disclosure also relates to an electrophotographic image forming apparatus comprising: an image carrier that carries a toner image; a transfer device that transfers the toner image to a recording material; and a fixing device that fixes the transferred toner image to the recording material, wherein the fixing device is the fixing device mentioned above.

The present disclosure also relates to a method of manufacturing the rotating fixing member mentioned above, the method includes preparing a stacked body in which the heat generating layer is formed on the base material; infiltrating a sulfide solution containing sulfide ions from a surface of the heat generating layer opposite to the another surface facing the base material; and removing the excess sulfide solution after the sulfide solution is infiltrated.

The present disclosure also relates to a method of manufacturing the rotating fixing member mentioned above, the method comprising: coating a liquid containing sulfide ions and silver nanoparticles on the base material; and forming the heat generating layer by baking the coated liquid.

The present disclosure also relates to a conductive member including a base material, and a heat generating layer on the base material. The heat generating layer contains silver, and silver sulfide is present at a surface of the heat generating layer opposite to another surface facing the base material.

The present disclosure further relates to a conductive member including a base material, and a heat generating layer on the base material. The heat generating layer contains silver, and at least one of the following conditions (A) and (B) is satisfied, (A): silver sulfide is present at a surface of the heat generating layer opposite to another surface facing the base material, (B): silver sulfide is present inside of the heat generating layer.

The present disclosure provides a rotating fixing member that is excellent in durability even in a printing environment where a high temperature state continues for a long time. The present disclosure also provides a fixing device including the rotating fixing member and an electrophotographic image forming apparatus. The present disclosure also provides a method of manufacturing the rotating fixing member. The present disclosure also provides a conductive member capable of curbing an increase in resistance at high temperatures.

Further features of the present disclosure will become apparent from the following description of exemplary embodiments with reference to the attached drawings.

### BRIEF DESCRIPTION OF THE DRAWINGS

FIG. 1 is a cross-sectional view of a heat generating layer formed of a silver nano-ink according to the present disclosure.

FIG. 2 is a schematic diagram of an electrophotographic image forming device according to an embodiment.

FIG. 3 is a schematic diagram showing a cross-sectional configuration of a fixing device according to an embodiment.

FIG. 4 is a schematic diagram showing a cross-sectional configuration of a fixing device according to an embodiment.

FIG. 5 is a schematic diagram of a magnetic core and an exciting coil of a fixing device according to an embodiment.

FIG. 6 is a diagram showing a magnetic field formed when a current is applied to an exciting coil according to an embodiment.

FIG. 7 is a cross-sectional configuration diagram of a rotating fixing member according to an embodiment.

FIGS. 8A and 8B are schematic diagrams showing a film forming mechanism of a silver nano-ink forming a heat generating layer of a rotating fixing member according to an embodiment.

FIGS. 9A and 9B show a cross-sectional image and a binarized image of a heat generating layer of a rotating fixing member according to an embodiment.

FIG. 10 is a cross-sectional configuration diagram of a heat generating layer of a rotating fixing member according to an embodiment.

### DESCRIPTION OF THE EMBODIMENTS

Unless otherwise specified, descriptions of numerical ranges such as “from XX to YY” or “XX to YY” in the present disclosure include the numbers at the upper and lower limits of the range. When numerical ranges are described in stages, the upper and lower limits of each of each numerical range may be combined arbitrarily. In the present disclosure, wording such as “at least one selected from the group consisting of XX, YY and ZZ” means any of: XX; YY; ZZ; a combination of XX and YY; a combination of XX and ZZ; a combination of YY and ZZ; or a combination of XX and YY and ZZ.

A rotating fixing member including a heat generating layer, a fixing device including the rotating fixing member, and an image forming apparatus according to the present disclosure will be described in detail with reference to the following specific configurations.

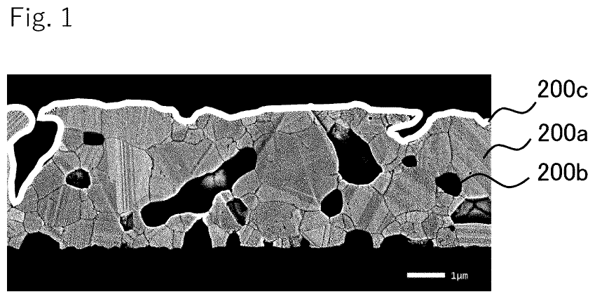

As described above, when the rotating fixing member using a silver nano-ink for manufacturing the heat generating layer is used, the resistance of the heat generating layer may increase when a high temperature state above a set temperature continues for a long time in a paper non-passing portion. FIG. 1 shows a cross-sectional view of a heat generating layer formed of a silver nano-ink. The heat generating layer formed using a silver nano-ink is characterized that the grain size of crystals 200a is smaller than bulk silver, and a grain boundary area is significantly large because it has pores 200b. For this reason, it is considered that a region reacting with oxygen is also enlarged, oxidation is more likely to occur as compared with bulk silver, and resistance is increased.

The inventors have found that silver sulfide is present at the surface of the heat generating layer opposite to another surface of the heat generating layer facing a base material, thereby curbing an increase in resistance of the heat generating layer even when a high temperature state continues for a long time. For example, the surface of the heat generating layer on the side opposite to the side facing the base material is sulfurized.

The inventors have considered that the reason why an increase in resistance of the heat generating layer can be curbed by silver sulfide is that the surface of the heat generating layer is covered with a dense silver sulfide layer 200c to form a barrier layer, the amount of contact between the heat generating layer and oxygen is reduced, and an increase in resistance can be curbed even in a high-temperature state. For example, the heat generating layer includes a layer containing silver sulfide (silver sulfide layer) at the surface of the heat generating layer opposite to the side facing the base material.

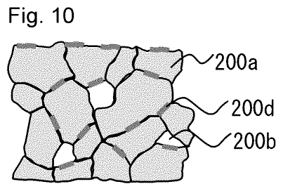

The inventors have also found that the presence of silver sulfide inside the heat generating layer can also curb the increase in resistance of the heat generating layer even when high-temperature conditions persist for a long time. For example, the inside of the heating layer is treated with sulfide. FIG. 10 shows a cross-sectional view of a heat generating layer with silver sulfide inside.

The inventors believe that the inner walls of the pores inside the heat generating layer and the grain boundaries of the silver crystals include silver sulfide 200d, thereby the amount of oxygen that the heating layer comes in contact with are reduced and the increase in resistance is suppressed even in high temperature conditions. For example, the heat generating layer contains silver sulfide inside the heat generating layer.

It is preferred that the silver sulfide is present both at the surface on the heat generating layer on the opposite to the side facing the base material and inside of the heat generating layer.

A rotating fixing member including a heat generating layer, a fixing device including the same, and an electrophotographic image forming apparatus will be described in detail below with reference to specific configurations.

However, the dimensions, materials and shapes of components described in this embodiment, relative arrangements thereof, and the like should be changed appropriately depending on the configurations of members to which the disclosure is applied and various conditions. That is, the scope of this disclosure is not intended to be limited to the following forms. In the following description, components having the same function are denoted by the same reference numerals in the drawings, and description thereof may be omitted.

Reference numerals in the drawings are as follows.

1 denotes an image forming apparatus, 15 denotes a fixing device, 20 denotes a rotating fixing member, 20a denotes a base material, 20b denotes a heat generating layer, 20c denotes an elastic layer, 20d denotes a surface layer, 20e denotes a protective layer, 20f denotes an adhesive layer, 21 denotes a pressure roller, 200a denotes a crystal of silver, 200b denotes a pore, and 200c and 200d denote silver sulfide.

### Electrophotographic Image Forming Device

An electrophotographic image forming apparatus (hereinafter simply referred to as “image forming apparatus”) includes an image carrier carrying a toner image, a transfer device transferring the toner image to a recording material, and a fixing device fixing the transferred toner image to the recording material.

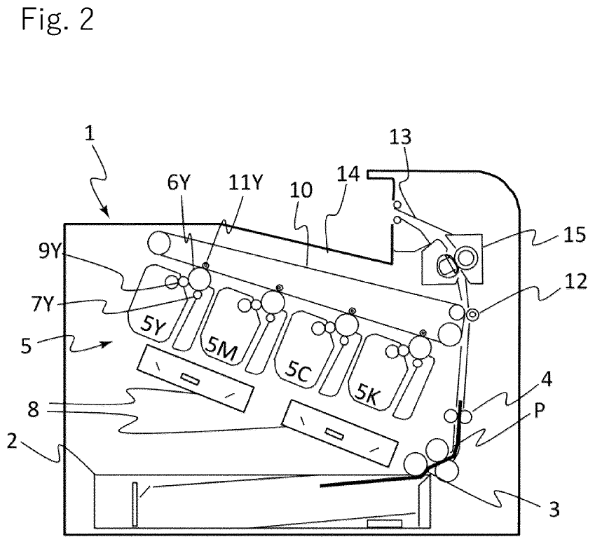

FIG. 2 is a cross-sectional view showing the overall configuration of a color laser beam printer (hereinafter referred to as a printer) 1 as an example of an image forming apparatus equipped with a fixing device (image heating device) 15 according to an embodiment. A cassette 2 is accommodated in a lower portion of the printer 1 that can be pulled out. A sheet P, which is a recording material, are loaded and accommodated in the cassette 2. The sheets P in the cassette 2 are fed to a registration roller 4 while being separated one by one by a separation roller 3.

As the sheet P that is a recording material, various sheets of different sizes and materials, for example, paper such as plain paper and thick paper, a plastic film, fabric, a sheet material subjected to a surface treatment such as coated paper, and a sheet material having a special shape such as an envelope or index paper can be used.

The printer 1 includes an image forming unit 5 as an image forming means in which image forming stations 5Y, 5M, 5C, and 5K corresponding to respective colors of yellow, magenta, cyan and black are arranged side by side in a horizontal row. The image forming station 5Y is provided with a photoreceptor drum 6Y, which is an image carrier (electrophotographic photoreceptor), and a charging roller 7Y as a charging means for uniformly charging the surface of the photoreceptor drum 6Y.

Further, a scanner unit 8 is disposed below the image forming unit 5. The scanner unit 8 forms an electrostatic latent image on the photoreceptor drum 6Y by emitting a laser beam that is on/off modulated in response to a digital image signal input from an external apparatus, such as a computer (not shown), on the basis of image information and generated by an image processing means. Further, the image forming station 5Y is provided with a developing roller 9Y as a developing means for developing the electrostatic latent image of the photoreceptor drum 6Y as a toner image (toner image) by sticking toner to the electrostatic latent image, and a primary transfer unit 11Y for transferring the toner image on the photoreceptor drum 6Y to an intermediate transfer belt 10.

Toner images formed by the same process in the other image forming stations 5M, 5C and 5K are multiply transferred to the toner image on the intermediate transfer belt 10 to which the toner image is transferred in the primary transfer unit 11Y. Thereby, a full-color toner image is formed on the intermediate transfer belt 10. The full-color toner image is transferred to the sheet P by a secondary transfer unit 12 as a transfer means. The primary transfer unit 11Y and the secondary transfer unit 12 are examples of transfer devices that fix a transferred toner image to a recording material.

Thereafter, the toner image transferred onto the sheet P (on the recording material) passes through the fixing device 15 and is fixed as a fixed image. Further, the sheet P passes through a discharge conveyance unit 13 and is discharged and loaded on a loading unit 14.

The image forming unit 5 is an example of an image forming means, and the image forming apparatus may use, for example, a configuration that directly transfers a toner image from the image carrier to the sheet P, or a monochromatic configuration using only one color of toner.

### Fixing Device

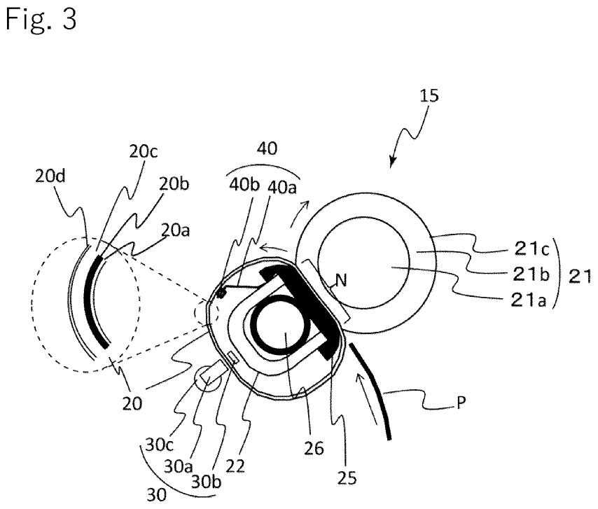

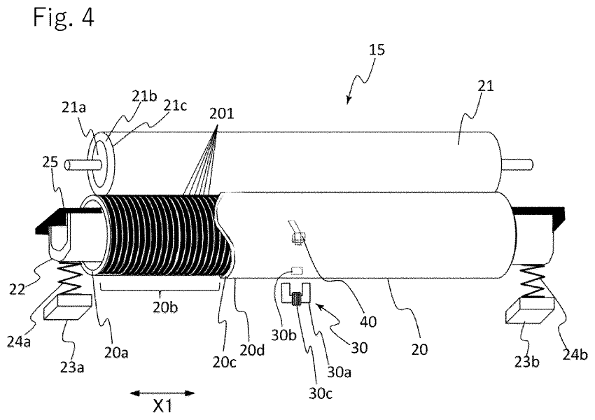

The fixing device 15 of this embodiment is an induction heating type fixing device (image heating device) that causes the rotating fixing member to generate heat by electromagnetic induction. FIG. 3 shows a cross-sectional configuration of the fixing device 15, and FIG. 4 is a perspective view of the fixing device 15. The housing and the like of the fixing device 15 are not shown in FIGS. 3 and 4. In the following description, a longitudinal direction X1 of the members configuring the fixing device 15 is a direction orthogonal to the conveyance direction of the recording material and the thickness direction of the recording material.

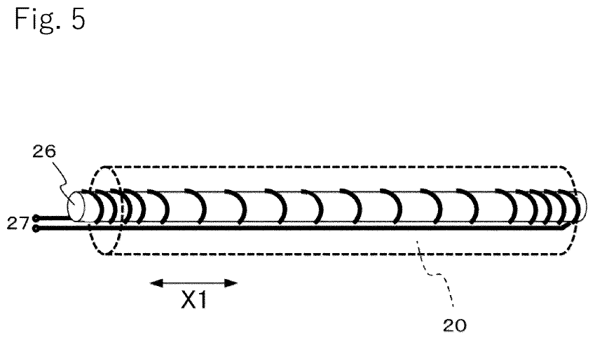

The fixing device 15 includes the rotating fixing member 20, a film guide 25, a pressure roller 21, a pressing stay 22, a magnetic core 26, an exciting coil 27 (FIG. 5), a thermistor 40, and a current sensor 30. The fixing device 15 fixes an image to the recording material by heating the recording material on which the image is formed. The rotating fixing member 20 is a rotating member of this embodiment, and the pressure roller 21 is an opposing member of this embodiment. The exciting coil 27 functions as a magnetic field generating means in this embodiment. Details of the rotating fixing member will be described later.

The rotating fixing member 20 includes the heat generating layer 20b on the base material 20a. The heat generating layer 20b can generate heat by, for example, an induced current. The heat generating layer 20b is formed in a ring shape by being electrically connected in the circumferential direction, and heat generating rings 201 (FIG. 4) electrically separated in the longitudinal direction X1 (the rotation axis direction of the rotating fixing member 20) are formed as heat generating patterns arranged in the longitudinal direction. That is, the heat generating layer 20b is divided into a plurality of annular regions each of which is connected in the circumferential direction of the rotating fixing member 20 and which are not electrically connected to each other in the rotation axis direction of the rotating fixing member 20. The heat generating rings 201, which are components of the heat generating pattern, are formed with a substantially uniform width in the longitudinal direction X1.

That is, the heat generating layer has a plurality of segments (for example, heat generating rings) arranged in the longitudinal direction of the rotating fixing member and electrically separated from each other, it is preferable that each of the plurality of segments be continuously formed over the entire region of the rotating fixing member in the circumferential direction.

The pressure roller 21 as an opposing body (pressure member) facing the rotating fixing member 20 includes a core bar 21a and an elastic layer 21b concentrically and integrally molded around the core bar in a roller shape, and a release layer 21c is provided on a surface layer. It is preferable that the elastic layer 21b be formed of a material having excellent heat resistance, such as silicone rubber, fluorine rubber, or fluorosilicone rubber. Both ends of the core bar 21a in the longitudinal direction are rotatably held and disposed between chassis side sheet metals (not shown) of the device via a conductive bearing.

Further, as shown in FIG. 4, pressing springs 24a, 24b are provided in a compressed manner between both ends of the pressing stay 22 in the longitudinal direction and spring receiving members 23a, 23b on the device chassis side, respectively, to apply a pressing force to the pressing stay 22.

In the fixing device 15 of this embodiment, a pressing force of a total pressure of approximately 100 N to 300 N (approximately 10 kgf to approximately 30 kgf) is applied. Thereby, the lower surface of the film guide 25 formed of a heat-resistant resin, such as PPS, and the upper surface of the pressure roller 21 are brought into pressure contact with each other across the rotating fixing member 20, which is a cylindrical rotating member, to form a fixing nip portion N having a predetermined width.

The film guide 25, together with the pressure roller 21, functions as a nip portion forming member that forms a nip portion that holds and conveys a recording material carrying a toner image through the rotating fixing member 20. Here, the PPS means polyphenylene sulfide.

The pressure roller 21 is driven to rotate in the clockwise direction by a drive means (not shown), and a counterclockwise rotational force is applied to the rotating fixing member 20 by a frictional force with the outer surface of the rotating fixing member 20. Thereby, the rotating fixing member 20 rotates while sliding on the film guide 25.

FIG. 5 is a schematic diagram of the magnetic core 26 and the exciting coil 27 shown in FIG. 3, and the rotating fixing member 20 is shown by a dashed line in order to explain a positional relationship with the rotating fixing member 20. An induction heating device in an induction heating type fixing device that causes the rotating fixing member 20 to generate heat by electromagnetic induction may include the magnetic core 26 and the exciting coil 27.

The exciting coil 27 is disposed inside the rotating fixing member 20. The exciting coil 27 includes a spiral shape portion of which the spiral axis is substantially parallel to a direction along the rotation axis of the rotating fixing member 20, and forms an alternating magnetic field for making the heat generating layer 20b generate heat by electromagnetic induction. “Substantially parallel” means that two axes allow not only a completely parallel state but also a slight deviation to the extent that the heat generating layer can be heated by electromagnetic induction.

The magnetic core 26 is disposed in the spiral shape portion, extends in the rotation axis direction of the rotating fixing member 20, and does not form a loop outside the rotating fixing member 20. The magnetic core 26 induces lines of magnetic force of an alternating magnetic field.

In FIG. 5, the magnetic core 26 is inserted into a hollow portion of the rotating fixing member 20, which is a cylindrical rotating member. The exciting coil 27 is spirally wound around the outer periphery of the magnetic core 26 and extends in the longitudinal direction of the rotating fixing member 20. The magnetic core 26 has a cylindrical shape and is fixed by a fixing means (not shown) so as to be located substantially at the center of the rotating fixing member 20 in a cross-section viewed in the longitudinal direction (see FIG. 3).

The magnetic core 26 provided inside the exciting coil 27 has a role of guiding the lines of magnetic force (magnetic flux) of the alternating magnetic field generated by the exciting coil 27 to the inside of the heat generating layer 20b of the rotating fixing member 20 and forming a path (magnetic path) for the lines of magnetic force. The material of the magnetic core 26 is preferably a material having a small hysteresis loss and a high relative magnetic permeability, for example, at least one soft magnetic material having a high magnetic permeability selected from the group consisting of baked ferrite, ferrite resin, and the like.

The cross-sectional shape of the magnetic core 26 may be any shape that can be accommodated in the hollow portion of the rotating fixing member 20, and although it is not necessary to have a circular shape, it is preferable that the cross-sectional area can be enlarged as far as possible. In the present embodiment, the diameter of the magnetic core 26 was 10 mm and the length in the longitudinal direction was 280 mm.

The exciting coil 27 was formed by spirally winding a copper wire (single conductor) having a diameter of 1 mm to 2 mm covered with heat-resistant polyamide imide in 20 turns around on the magnetic core 26. The exciting coil 27 is wound around the magnetic core 26 in a direction crossing the rotation axis direction of the rotating fixing member 20. For this reason, when a high-frequency alternating current is applied to the exciting coil 27, an alternating magnetic field is generated in a direction parallel to the rotation axis direction, and an induced current (circulating current) flows through each heat generating ring 201 of the heat generating layer 20b of the rotating fixing member 20 in accordance with the principle to be described below to generate heat.

As shown in FIGS. 3 and 4, the thermistor 40 as a temperature detecting means for detecting the temperature of the rotating fixing member 20 is configured with a spring plate 40a and a thermistor element 40b. The spring plate 40a is a support member having spring elasticity extending toward the inner surface of the rotating fixing member 20. The thermistor element 40b as a temperature detection element is installed at the tip of the spring plate 40a. The surface of the thermistor element 40b is covered with a polyimide tape having a thickness of 50 μm to ensure electrical insulation.

The thermistor 40 is fixed to the film guide 25 at a position substantially in the center of the rotating fixing member 20 in the longitudinal direction. Then, the thermistor element 40b is pressed against the inner surface of the rotating fixing member 20 by the spring elasticity of the spring plate 40a and held in a contact state. The thermistor 40 may be disposed on the outer peripheral side of the rotating fixing member 20.

A current sensor 30 constituting a conduction monitoring device for monitoring the conduction in the circumferential direction of the heat generating layer 20b is arranged at the same position as the thermistor 40 in the longitudinal direction of the fixing device 15. That is, the current sensor 30 monitors the state of conduction of the heat generating ring 201 located at a position in contact with the thermistor element 40b among the plurality of heat generating rings 201 constituting the heat generating pattern of the rotating fixing member 20. The current sensor 30 is composed of an outer magnetic core 30a, an inner magnetic core 30b, and a detection coil 30c.

### Heating Principle

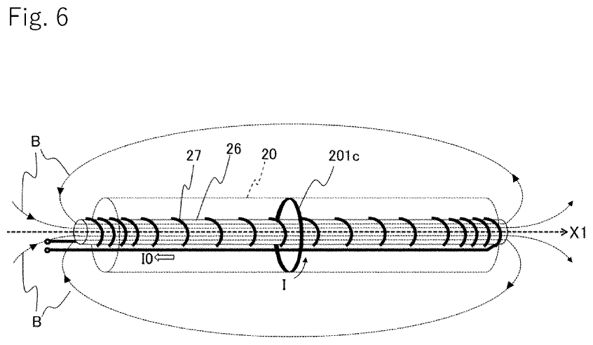

The heating principle of the rotating fixing member 20 in the induction heating type fixing device 15 will be described below. FIG. 6 is a concept diagram showing the moment the current is increasing in the direction of arrow I0 in the exciting coil 27. The exciting coil 27 is inserted into the rotating fixing member 20, forms an alternating magnetic field in the rotation axis direction of the rotating fixing member 20 by flowing an alternating current, and functions as a magnetic field generating means for generating an induced current I in the circumferential direction of the rotating fixing member 20.

Further, the magnetic core 26 functions as a member that induces a line of magnetic force B (dotted line in the figure) generated by the exciting coil 27 and forms a magnetic path. A general induction heating system is configured such that lines of magnetic force penetrate through the heat generating layer to generate an eddy current, whereas lines of magnetic force B loops on the outside of the rotating fixing member in this embodiment. That is, the heat generating layer 20b is mainly heated by an induced current induced by lines of magnetic force coming out of one longitudinal end of the magnetic core 26, passing through the outside of the heat generating layer 20b, and returning to the other longitudinal end of the magnetic core 26. Thus, even when the thickness of the heat generating layer is as thin as 5 μm or less, heat can be efficiently generated.

When an alternating magnetic field is formed by the exciting coil 27, an induced current I according to the Faraday's law flows through each heat generating ring 201 of the heat generating layer 20b of the rotating fixing member 20. The Faraday's law is “when a magnetic field in a circuit is changed, an induced electromotive force for applying a current into the circuit is generated, and the induced electromotive force is proportional to a change over time in a magnetic flux vertically penetrating the circuit”.

Regarding a heat generating ring 201c located at the center of the magnetic core 26 shown in FIG. 6 in the longitudinal direction, an induced current I flowing through the heat generating ring 201c when a high-frequency alternating current flows through the exciting coil 27 is considered. When a high-frequency alternating current flows, an alternating magnetic field is formed inside the magnetic core 26. The induced electromotive force acting on the heat generating ring 201c at that time is proportional to a change over time in the magnetic flux vertically penetrating the inside of the heat generating ring 201c in accordance with the following formula.

$$V = - N \frac{ΔΦ}{Δ t}$$

V: Induced electromotive force
N: Number of turns of coil
ΔΦ/Δt: Change in magnetic flux vertically penetrating circuit (heat generating ring 201c) at minute time Δt.

An induced current I, which is a circulating current circulating around the heat generating ring 201c, flows by the induced electromotive force V, and the heat generating ring 201c generates heat by the Joule heat generated with the induced current I. However, when the heat generating ring 201c is disconnected, the induced current I does not flow and the heat generating ring 201c does not generate heat.

### (1) Outline of Configuration of Rotating Fixing Member

Details of the rotating fixing member of this embodiment will be described with reference to the drawings.

The rotating fixing member according to one aspect of the disclosure can be a rotatable member, for example, in the shape of an endless belt. The rotating fixing member includes a base material containing a resin, a heat generating layer on the base material, and a resin layer on a surface of the heat generating layer opposite to another surface of the heat generating layer facing the base material.

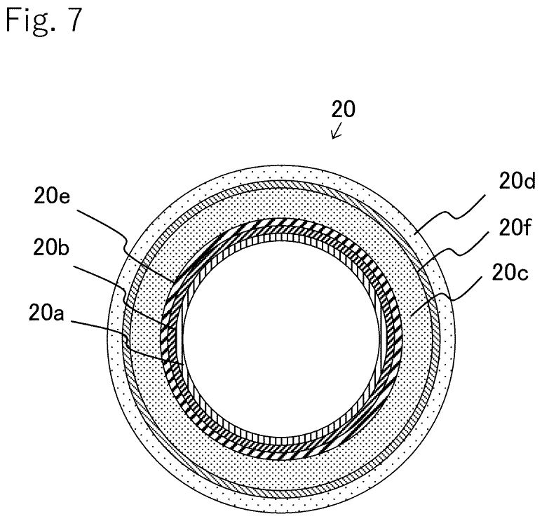

FIG. 7 is a cross-sectional view of the rotating fixing member in the circumferential direction. As shown in FIG. 7, the rotating fixing member includes the base material 20a, the heat generating layer 20b on the outer surface of the base material 20a, and the resin layer (protective layer) 20e on the outer surface of the heat generating layer. The resin layer includes, for example, a protective layer. For the resin layer, the elastic layer 20c and the surface layer (release layer) 20d may be further provided on the protective layer 20e as necessary, and the adhesive layer 20f can also be provided between the elastic layer 20c and the surface layer 20d.

### (2) Base Material

The material of the base material 20a is not particularly limited. The base material 20a contains a resin (preferably a heat-resistant resin). When a belt is used for an electromagnetic induction type fixing device, it is preferable that the base material 20a be a layer which has little change in physical properties and maintains high strength in a state where the heat generating layer generates heat. For this reason, it is preferable that the base material 20a contain a heat-resistant resin as a main component, and it is more preferable that the base material 20a be formed of a heat-resistant resin.

It is preferable that the resin contained in the base material 20a (preferably the resin constituting the base material) contains at least one selected from the group consisting of polyimide (PI), polyamide-imide (PAI), modified polyimide, and modified polyamide-imide. More preferably, the resin is at least one selected from the group consisting of polyimide and polyamide-imide. Among these, polyimide is particularly preferable. In the disclosure, the main component means a component that is contained in the largest amount among the components configuring the object (here, the base material).

Examples of the modification in the modified polyimide and the modified polyamide-imide include modified siloxane, modified carbonate, modified fluorine, modified urethane, modified triazine, modified phenol, and the like.

A filler may be incorporated in the base material 20a to improve thermal insulation and strength.

The shape of the base material can be appropriately selected in accordance with the shape of the rotating fixing member, and for example, various shapes such as an endless belt shape, a cylindrical hollow shape, and a film shape can be used.

In the case of a fixing belt, the thickness of the base material 20a is preferably, for example, 10 μm to 100 μm, more preferably, 20 μm to 60 μm. The thickness of the base material 20a is set to be in the above range, and thus both strength and flexibility can be achieved at high levels.

In addition, for example, a layer for preventing wear of the inner peripheral surface of the fixing belt when the inner peripheral surface of the fixing belt contacts another member or a layer for improving a sliding property with respect to the other member may be provided on the surface of the base material 20a opposite to another surface of the heat generating layer facing the heat generating layer 20b.

Another member such as a sliding member is disposed on the inner surface of the base material 20a, and a sliding load is large. For this reason, in order to ensure durability as a base material, the base material is preferably a solid layer.

The outer peripheral surface of the base material 20a may be subjected to a surface roughening treatment such as blasting, or a modification treatment such as that with ultraviolet rays, plasma, or chemical etching in order to improve adhesion and wettability with respect to the heat generating layer 20b.

### (3) Heat Generating Layer

The heat generating layer 20b is a layer that generates heat when electrified. In the principle of heat generation by induction heating using an exciting coil, when an alternating current is supplied to the exciting coil disposed in the vicinity of the rotating fixing member, a magnetic field is induced, a current is generated in the heat generating layer 20b of the rotating fixing member by the magnetic field, and heat is generated by the Joule heat. The heat generating layer extends in the circumferential direction of the outer peripheral surface of the base material.

The heat generating layer contains silver. Silver has a low volume resistivity and is less likely to be oxidized. The content of silver with respect to the entire heat generating layer 20b is preferably 90.0 mass % or more, more preferably 99.0 mass % or more, and particularly preferably 99.9 mass % or more. Examples of the upper limit include 99.999 mass % or less and 99.99 mass % or less.

The volume resistivity of the heat generating layer 20b is preferably in the range of 1.0×10⁻⁸ to 8.0×10⁻⁸ Ω·m, the range of 2.0×10⁻⁸ to 7.0×10⁻⁸ Ω·m, or the range of 2.0×10⁻⁸ to 6.0×10⁻⁸ Ω·m.

The number average crystal grain size of the silver crystal contained in the heat generating layer is preferably 500 nm or less. When the number average crystal grain size is within the above range, even when stress is repeatedly applied to the rotating fixing member 20 by being pressurized and deformed at the nip portion N, a large number of stable crystal interfaces are formed on the heat generating layer 20b, and thus the occurrence of cracks at the crystal interfaces is curbed. The number average crystal grain size of the silver crystal is preferably 10 to 500 nm, more preferably 100 to 450 nm, further preferably 150 to 400 nm, and still more preferably 170 to 350 nm.

The number average crystal grain size can be controlled by the baking conditions at the time of forming the heat generating layer. The grain size is increased by increasing a baking temperature and increasing a period of time, and the grain size is reduced by decreasing a baking temperature and reducing a period of time.

It is preferable that the heat generating layer have pores. It is preferable that the heat generating layer have pores in a cross-sectional view in the circumferential direction. Specifically, at least one pore exists in a cross-section in a direction along the circumferential direction of the heat generating layer. The presence of pores in the heat generating layer provides an effect of improving durability by an anchor effect when forming the protective layer. From the viewpoint of conductivity and durability, it is preferable to adjust the amount of pores and the size of the pores.

As a method of providing pores in the heat generating layer 20b, for example, after a pattern is formed on the heat generating layer 20b by a photolithography process, holes are formed by chemical etching or holes are formed by using a laser or a focused ion beam. In the disclosure, pore formation using a silver nano-particle material is particularly described.

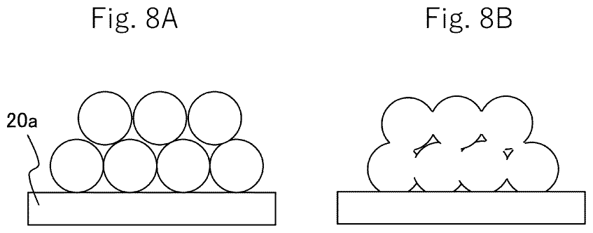

It is preferable that the heat generating layer be a baked body (sintered body) of silver nanoparticles and be a baked body of a coating film of a silver-nano ink. When a coating material mixed with silver nanoparticles having a particle size of approximately 10 to 50 nm is formed, particles are stacked as shown in FIG. 8A. Since the nanoparticles have unstable surface energy, the particles are fused to each other even by low-temperature baking of approximately 100° C., and can be formed into a film with nano-sized pores as shown in FIG. 8B. The size and number of pores can be expressed as a porosity.

Specifically, the proportion (porosity) of the pores in the cross-section of the heat generating layer, which is measured by observing the cross-section obtained by cutting the heat generating layer, which is sampled from the rotating fixing member, in the thickness direction is preferably 13 to 50 area %, more preferably 13 to 45 area %, further preferably 15 to 40 area %, still further preferably 15 to 30 area %, and particularly more preferably 15 to 22 area %.

The porosity can be increased by increasing the temperature at the time of baking the heat generating layer. Further, the porosity can be reduced by lowering the temperature at the time of baking the heat generating layer. The porosity may vary within a small range depending on the concentration of a sulfide solution.

Here, the number average crystal grain size and porosity of silver in the heat generating layer are determined as follows.

First, an evaluation sample is prepared. One sample having a length of 5 mm, a width of 5 mm and a thickness equal to the total thickness of the rotating fixing member is collected from the central portion of the rotating fixing member in the rotation axis direction. For the obtained sample, the cross-section of the rotating fixing member in the circumferential direction is polished by using an ion beam. At this time, a machining position is adjusted so that the cross-section of the heat generating layer in the circumferential direction is exposed by polishing using the ion beam.

An ion milling device (trade name: IM4000, manufactured by Hitachi High-Tech Corporation) can be used to polish the cross-section using the ion beam. In the polishing of the cross-section using the ion beam, falling out of a filler from the sample and mixing in of an abrasive can be prevented, and a cross-section with fewer polishing marks can be formed. Subsequently, the cross-section of the heat generating layer is observed with a scanning electron microscope (SEM) (trade name: JSM-F100, manufactured by JEOL Ltd.) to obtain a cross-sectional image and an energy dispersive X-ray spectroscopy (EDS) image. An observation condition is a 10,000-fold reflected electron image mode, and reflected electron image acquisition conditions are an acceleration voltage of 5.0 kV and a working distance of 4 mm.

Next, the resulting image is subjected to binarization processing by commercially available image software so that silver-containing metal crystal particle portions become white and portions other than the crystal particles become black. Specifically, a reflected electron image is read by image analysis software ImageProPlus manufactured by MediaCybernetics Inc., and a luminance distribution of the image is obtained. Next, by setting the luminance range of the obtained luminance distribution, binarization for distinguishing between the silver-containing metal crystal particles and parts other than the crystal particles can be performed. For example, the Otsu's method is used as a method for the binarization.

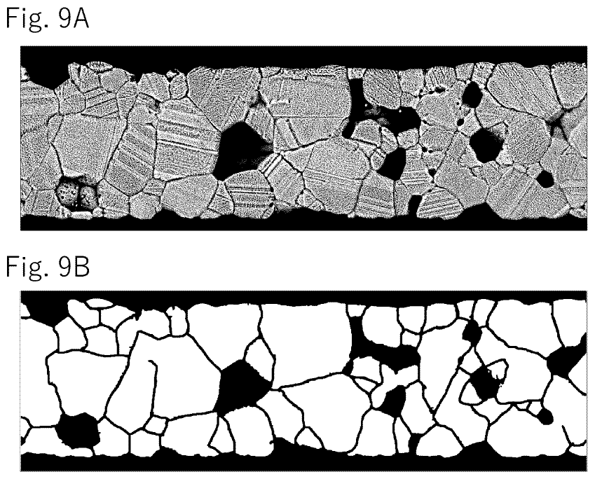

Then, a line dividing the crystal particles, which is obtained from a contrast difference due to a difference in brightness between the crystal particles or a difference in crystal orientation in FIG. 9A, which is a cross-sectional image, is added to a binarized image to obtain a binarized image in which the crystal particles are divided (FIG. 9B).

The portions filled in in black in FIG. 9B are pores included in the heat generating layer or materials of layers other than the heat generating layer, for example, polyimide or polyamide-imide as a base material. The materials of the layers other than the heat generating layer are black parts above and below the heat generating layer in FIG. 9B.

It can be confirmed from the EDS image that the portions filled in in black are the materials of the layers other than the heat generating layer on the basis of the proportion of the elements in the portions filled in in black. For example, in the portions filled in in black, elements inherent to a resin such as the base material may be confirmed. In the portions filled in in black, portions other than the materials of the layers other than the heat generating layer can be determined to be pores.

A method of calculating the number average crystal grain size from the binarized image of the cross-section of the heat generating layer obtained in this manner will be described. Since a digital image processing technique is applied to these images, it is assumed that all the images have a general digital image format in which pixels are arranged in a grid pattern. In addition, the binarized image is a gray scale image only including luminance information, and then, images obtained by performing image processing on these images are all gray scale images of the same format unless otherwise noted.

First, an equivalent circle diameter of each crystal particle is calculated. The equivalent circle diameter of each crystal particle means the diameter of a circle having the same area as the area of the crystal particle. Specifically, the number of pixels configuring each crystal particle is calculated, and the actual area of the crystal particle is calculated by multiplying the number of pixels by the area of one pixel.

In the SEM image used in the disclosure, the length of one side of one pixel is equivalent to 0.01 μm, and thus the number of pixels configured with each crystal particle is multiplied by 0.01×0.01 μm². Further, the equivalent circle diameter is calculated by obtaining the diameter of a circle having this area.

Here, six samples are collected as follows. That is, as described above, one sample is collected from the central portion of the rotating fixing member in the rotation axis direction. When the length of the rotating fixing member in the rotation axis direction is L, one sample is also collected from a portion separated from the central portion by 0.1 L in the rotation axis direction. From each sampling point, a total of six samples are collected similarly at portions 1200 and 240° away in the circumferential direction of the rotating fixing member.

The total sum of the equivalent circle diameters of the crystal particles obtained in this manner is divided by the total number of crystal particles to calculate an average crystal grain size.

The above operations are repeatedly performed for the six samples collected from the rotating fixing member to calculate the average crystal grain size of each of the samples. Further, the arithmetic mean value of these six number average crystal grain sizes is calculated to calculate the number average crystal grain size of silver crystals in the heat generating layer.

Further, a method of calculating a porosity from the binarized image of the cross-section of the heat generating layer obtained by the above procedure will be described.

In the position of the heat generating layer of the binarized image acquired by the above procedure, an image of 2.0 μm×2.0 μm in size is cut out. Four images are cut out from one SEM image. The position where the image is cut out is set as a position where the center of the heat generating layer in the thickness direction is the center position of the cut-out image in the vertical direction. In addition, the four images are cut out such that intervals of the four images are the same in a direction orthogonal to the thickness direction of the heat generating layer. The above operations are performed for six SEM images to obtain cross-sectional images of 24 locations.

Particles of a silver-containing metal crystal are expressed as white regions, and an area occupied by the crystal particles in an image is calculated. Specifically, the number of pixels configuring each crystal particle is calculated, and the sum of the number of pixels is calculated. By multiplying the sum of the number of pixels by 0.01×0.01 μm² which is the area of one pixel, an area occupied by the crystal particles can be calculated.

Further, as described above, the black-filled region is a pore or a material of a layer other than the heat generating layer. Consequently, an area occupied by the materials other than the heat generating layer in the black-filled region is calculated. Specifically, the number of pixels configuring each of the materials other than the heat generating layer is calculated, and the total sum of the number of pixels is calculated. By multiplying the sum of the number of pixels by 0.01×0.01 μm², which is the area of one pixel, an area occupied by the materials other than the heat generating layer can be calculated.

Since a porosity indicates the proportion of a space that is not occupied by the crystal particles or the materials other than the heat generating layer, the porosity can be expressed as follows using the area occupied by the crystal particles and the area occupied by the materials other than the heat generating layer, which are obtained above.

Porosity=(2.0×2.0 (μm²)−area occupied by crystal particles (μm²)−area occupied by materials other than heat generating layer (μm²))/(2.0×2.0 (μm²))×100

The porosity is calculated for 24 locations in the range of 2.0 μm×2.0 μm in size of the cross-sectional image of the heat generating layer, and an average porosity obtained by the arithmetic mean is set as the porosity of the heat generating layer.

The thickness of the heat generating layer 20b is preferably 5 μm or less. This is because the rotating fixing member should have a moderate flexibility and a small heat capacity. Still another advantage is an improvement in flex resistance. As shown in FIG. 3, the rotating fixing member 20 is driven to rotate while being pressed by the film guide 25 and the pressure roller 21. With each rotation, the rotating fixing member 20 is pressurized and deformed at the nip portion N and receives stress.

It is preferable that the heat generating layer 20b of the rotating fixing member 20 be designed not to cause fatigue fracture even when the repeated bending is continuously applied during the durable life of the fixing device. When the thickness of the heat generating layer 20b is reduced, the resistance to fatigue fracture of the heat generating layer 20b is significantly improved. This is because, when the heat generating layer 20b is pressed and deformed along the shape of the curved surface of the film guide 25, an internal stress acting on the heat generating layer 20b becomes smaller as the heat generating layer 20b becomes thinner.

For the reasons described above, the thickness of the heat generating layer 20b is preferably 5 μm or less from the viewpoint of reducing heat capacity and further improving fatigue fracture resistance. The thickness of the heat generating layer 20b may be, for example, 1 to 5 μm, 2 to 5 μm, and 2 to 4 μm.

The heat generating layer 20b extends in the circumferential direction of the outer peripheral surface of the base material 20a. The heat generating layer 20b may generate heat when electrified and may be configured in a predetermined pattern. Particularly, as shown in FIG. 4, from the viewpoint of safety, it is preferable to adopt a configuration in which a plurality of heat generating layers 20b formed in a ring shape in the circumferential direction of the rotating fixing member be formed in an electrically divided state in the rotation axis direction. With such a configuration, a local temperature rise can be curbed when a crack occurs in the heat generating layer 20b. It is preferable that the ring shape has a substantially fixed width in the axial direction of the rotating body.

However, such a pattern configuration is adopted, the surface area of the heat generating layer 20b increases, and the risk of degradation due to oxidation increases. In the rotating fixing member according to the present disclosure, degradation can be curbed by the heat generating layer containing silver sulfide.

The width of the ring of the heat generating layer 20b is preferably 100 μm or more from the viewpoint of manufacturability and pyrogenicity, more preferably 200 μm or more, and still more preferably 250 μm or more. From the viewpoint of uneven heat generation and safety, the width of the ring is preferably 1000 μm or less, more preferably 900 μm or less, and still more preferably 700 μm or less. The width of the ring is, for example, 100 μm to 1000 μm, 200 μm to 900 μm, and 250 μm to 700 μm.

An interval between the rings of the heat generating layer 20b is preferably 50 μm or more from the viewpoint of manufacturability and pyrogenicity, and more preferably 100 μm or more. From the viewpoint of uneven heat generation, the interval is preferably 400 μm or less, and more preferably 300 μm or less. The interval between rings is, for example, 50 μm to 400 μm and 100 μm to 300 μm.

As described above, silver sulfide can be present at the surface of the heat generating layer (the surface on the resin layer side) opposite to another surface of the heat generating layer facing the base material. For example, a silver sulfide layer is formed by treating a sulfide solution containing a sulfide ion component with silver, and functions as a barrier layer that blocks oxygen. Although silver is a noble metal and is less likely to react with other components, it is very likely to react with sulfide ions to immediately form silver sulfide.

The heat generating layer containing silver sulfide in this manner can be formed, for example, by coating and infiltration of a sulfide solution containing sulfide ions. As a coating method, it is possible to use a dipping, spraying, flow coating, or contact coating using a sponge or the like. In the present disclosure, a coating method using a sponge will be described.

In order to infiltrate the sulfide solution into the heat generating layer, for example, the sulfide solution is infiltrated into a urethane sponge to trace the surface of the heat generating layer. The concentration of the sulfide ions in the sulfide solution is preferably, for example, 0.001 to 5.00 mass %, more preferably, 0.005 to 2.00 mass %, and more preferably, 0.005 to 1.00 mass %. It is preferable to remove the excess sulfide solution by washing away it with purified water and remove the remaining water by air blowing after tracing evenly.

Examples of the sulfide solution include those containing sulfide ion components, but include, for example, sodium sulfide, potassium sulfide, a lime-sulfur mixture (calcium polysulfide), and the like.

That is, it is preferable that a method of manufacturing the rotating fixing member include a step of preparing a stacked body having a heat generating layer formed on a base material, a step of infiltrating a sulfide solution containing sulfide ions from a surface of the heat generating layer opposite to another surface of the heat generating layer facing the base material, and a step of removing an excess sulfide solution after infiltrating the sulfide solution.

Oxidation may also proceed from the pores inside the heat generating layer and from the grain boundaries of the silver crystals contained in the heat generating layer. Therefore, a configuration in which silver sulfide is present inside the heat generating layer is acceptable (FIG. 10).

More specifically, the configuration may be that silver sulfide is present at the grain boundaries of silver crystals contained in the heat generating layer.

The configuration may also be that the heat generating layer has a pore in a cross-sectional view in a circumferential direction thereof, and silver sulfide is present on an inner wall of the pore.

The heat generating layer containing silver sulfide can be formed, for example, by coating a liquid containing sulfide ions and silver nanoparticles and baking the coated liquid.

Liquid containing sulfide ions and silver nanoparticles can be prepared by mixing a liquid containing sulfide ions and silver nano-ink. The mixing method includes a self-rotating agitator or mixer. After mixing, sulfide ions react with silver nanoparticles to form silver sulfide. The concentration of sulfide ions in the liquid containing sulfide ions, for example, 0.001 to 6.00 mass % is preferred, 1.50 to 5.00 mass % is more preferred, and 2.40 to 3.00 mass % is more preferred.

Liquids containing sulfide ions include, for example, sodium sulfide, potassium sulfide, and lime-sulfur compound (calcium polysulfide).

That is, the method of manufacturing the rotating fixing member preferably includes the processes of coating a liquid containing sulfide ions and silver nanoparticles on the base material, and forming the heat generating layer by baking the coated liquid.

The step of preparing the stacked body includes, for example, a step of obtaining a base material, and a step of obtaining a heat generating layer by coating an outer peripheral surface of the obtained base material with a silver nano-ink or a liquid containing sulfide ions and silver nanoparticles, and then baking it.

The step of obtaining the base material is not particularly limited. For example, a base material having an endless belt shape or a roller shape can be used. For example, a base material can be obtained by applying a resin material of the base material to the surface of a mold, such as a cylindrical shape, and heating it when necessary.

Next, a silver nano-ink or a liquid containing sulfide ions and silver nanoparticles is applied to the outer peripheral surface of the resulting base material and is baked (sintered) to form a heat generating layer. The temperature during the baking is not particularly limited, but is preferably 150° C. to 450° C. and more preferably 250° C. to 350° C. That is, the heat generating layer is preferably a baked body (sintered body) of silver nanoparticles. The baking time is also not particularly limited, and may be, for example, 10 to 120 minutes.

### (4) Resin Layer

The rotating fixing member includes a resin layer on a surface of the heat generating layer opposite to another surface of the heat generating layer facing the base material. In the present disclosure, a portion including the protective layer 20e, the elastic layer 20c, the adhesive layer 20f, and the surface layer 20d may be expressed as a resin layer. That is, it is preferable that the rotating fixing member include the resin layer including the protective layer 20e, the elastic layer 20c, the adhesive layer 20f, and the surface layer 20d on the surface of the heat generating layer opposite to another surface of the heat generating layer facing the base material. The resin layer may be only one protective layer or one surface layer. It is preferable that the resin layer include a protective layer.

### (5) Protective Layer

The rotating fixing member may include a protective layer on the surface of the heat generating layer opposite to another surface of the heat generating layer facing the base material. The protective layer 20e protects the heat generating layer 20b, and has a function of preventing oxidation, ensuring insulation, and improving strength of the heat generating layer 20b.

The material configuring the protective layer 20e is not particularly limited. It is preferable that the material of the protective layer 20e be a layer containing at least a resin. When a belt is used for an electromagnetic induction type fixing device, it is preferable that the protective layer 20e be a layer having little change in physical properties and maintaining high strength in a state where the heat generating layer 20b generates heat, similar to the base material 20a.

For this reason, the protective layer 20e preferably contains a heat-resistant resin, more preferably contains a heat-resistant resin as a main component, and preferably is formed of a heat-resistant resin. The heat-resistant resin is a resin that does not dissolve or decompose at a temperature of, for example, less than 200° C. (preferably less than 250° C.).

The resin configuring the protective layer 20e preferably contains at least one selected from the group consisting of polyimide (PI), polyamide-imide (PAI), modified polyimide, and modified polyamide-imide. More preferably, the resin is at least one selected from the group consisting of polyimide and polyamide-imide. Modification is similar to that described in the base material 20a.

Among these, polyimide is particularly preferable. The main component means a component that is contained in the largest amount among the components configuring the object (here, the protective layer). Methods of forming the base material 20a and the protective layer 20e are not particularly limited. For example, an imide-based material can be formed into a film in a liquid form of varnish by applying and baking it using a known method.

The protective layer 20e may contain a thermally conductive filler from the viewpoint of a heat transfer property. By improving a heat transfer property, heat generated in the heat generating layer 20b can be efficiently transferred to the outer peripheral surface of the rotating fixing member.

The thickness of the protective layer 20e is preferably 10 μm to 100 μm, and more preferably 20 μm to 60 μm. From the viewpoint of bending resistance of the heat generating layer 20b, it is preferable that the thickness of the protective layer 20e be adjusted such that the heat generating layer 20b is positioned on the neutral axis. The neutral axis can be calculated from the thickness and elastic modulus of the base material 20a, and the thickness and elastic modulus of the protective layer 20e. Since the heat generating layer 20b is positioned on the neutral axis, when the heat generating layer 20b is repeatedly bent, stress applied to the heat generating layer 20b is not biased, and thus it is possible to curb the occurrence of a crack in the heat generating layer 20b.

### (6) Elastic Layer

The rotating fixing member may include the elastic layer 20c on the outer surface of the protective layer 20e. The elastic layer 20c is a layer for imparting flexibility to the rotating fixing member in order to secure a fixing nip in the fixing device. When the rotating fixing member is used as a heating member in contact with toner on paper, the elastic layer 20c also functions as a layer for imparting flexibility making the surface of the heating member may follow the unevenness of the paper.

The elastic layer 20c contains, for example, rubber as a matrix and particles dispersed in the rubber. More specifically, it is preferable that the elastic layer 20c contain rubber and a thermally conductive filler, and it is preferable that the elastic layer 20c is formed of a cured material obtained by curing a composition containing at least raw materials of the rubber (a base polymer, a crosslinking agent, and the like) and a thermally conductive filler.

The thickness of the elastic layer may be, for example, 100 μm to 1000 μm and 200 μm to 500 μm.

From the viewpoint of exhibiting the function of the elastic layer 20c described above, it is preferable that the elastic layer 20c be formed of a silicone rubber cured material containing thermally conductive particles, and it is more preferable that the elastic layer 20c be formed of a cured material of an addition curing silicone rubber composition.

The silicone rubber compositions may include thermally conductive particles, base polymers, cross-linking agents and catalysts, as well as additives when necessary. Since the silicone rubber composition is mostly liquid, the thermally conductive filler is easily dispersed, and the elasticity of the elastic layer 20c to be manufactured is easily adjusted by adjusting the degree of crosslinking in accordance with the type and addition amount of the thermally conductive filler.

The matrix functions to exhibit elasticity in the elastic layer 20c. It is preferable that the matrix contain silicone rubber from the viewpoint of exhibiting the function of the elastic layer 20c. The silicone rubber is preferably since it has high heat resistance capable of maintaining flexibility even under a high temperature of approximately 240° C. in the paper non-passing portion. As the silicone rubber, for example, a cured material of an addition curing liquid silicone rubber composition to be described later can be used. The elastic layer 20c can be formed by applying and heating the liquid silicone rubber composition by a known method.

The liquid silicone rubber composition typically contains the following components (a) to (d):
Component (a): organopolysiloxane having an unsaturated aliphatic group
Component (b): organopolysiloxane having active hydrogen bonded to silicon
Component (c): catalysts
Component (d): thermally conductive filler

Each component will be described below.

### Component (a)

The organopolysiloxane having an unsaturated aliphatic group is organopolysiloxane having an unsaturated aliphatic group, such as a vinyl group, and includes, for example, those shown in Formulas (1) and (2) below.

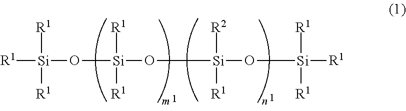

In Formula (1), m¹ represents an integer of 0 or more, and n¹ represents an integer of 3 or more. Further, in Formula (1), R¹ is each independently represents a monovalent unsubstituted or substituted hydrocarbon group that does not contain an unsaturated aliphatic group, where at least one of R¹ represents a methyl group, and R² is each independently represents an unsaturated aliphatic group.

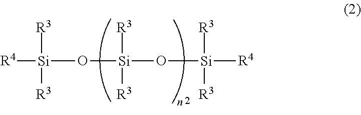

In Formula (2), n² represents a positive integer, and R³ is each independently represents a monovalent unsubstituted or substituted hydrocarbon group that does not contain an unsaturated aliphatic group, where at least one of R³ represents a methyl group, and R⁴ is each independently represents an unsaturated aliphatic group.

Examples of the monovalent unsubstituted or substituted hydrocarbon group that does not contain an unsaturated aliphatic group and which can be represented by R¹ and R³ in Formulas (1) and (2) may include the following groups.

### Unsubstituted Hydrocarbon Group

Alkyl group (for example, methyl group, ethyl group, propyl group, butyl group, pentyl group, hexyl group)
Aryl group (for example, phenyl group)

### Substituted Hydrocarbon Group

Substituted alkyl group (for example, chloromethyl group, 3-chloropropyl group, 3,3,3-trifluoropropyl group, 3-cyanopropyl group, 3-methoxypropyl group)

The organopolysiloxane represented by Formulas (1) and (2) has at least one methyl group directly bonded to a silicon atom forming a chain structure. However, because of the ease of synthesis and handling, it is preferable that 50% or more of each of R¹ and R³ be methyl groups, and it is more preferable that all of R¹ and R³ be methyl groups.

In addition, examples of the unsaturated aliphatic group that can be represented by R² and R⁴ in Formulas (1) and (2) may include the following groups: That is, examples of the unsaturated aliphatic group may include a vinyl group, an allyl group, a 3-butenyl group, a 4-pentenyl group, a 5-hexenyl group, and the like. Among these groups, both R² and R⁴ are preferably a vinyl group because they are easily synthesized and handled, have a low cost, and a crosslinking reaction is easily performed.

From the viewpoint of moldability, the viscosity of the component (a) is preferably from 1000 mm²/s to 50000 mm²/s. When the viscosity is 1000 mm²/s or more, a hardness required for the elastic layer 20c is easily adjusted, and when the viscosity is 50000 mm²/s or less, coating is easier. The viscosity (kinetic viscosity) can be measured using a capillary viscometer, a rotational viscometer, or the like on the basis of JIS Z 8803:2011.

The compounding amount of the component (a) is preferably 55 vol % or more from the viewpoint of durability and 65 vol % or less from the viewpoint of heat transfer, on the basis of the liquid silicone rubber composition used for forming the elastic layer 20c.

### Component (b)

Organopolysiloxane having active hydrogen bonded to silicon reacts with the unsaturated aliphatic group of the component (a) by the action of a catalyst, and functions as a crosslinking agent for forming a cured silicone rubber.

As the component (b), any organopolysiloxane having a Si—H bond can be used. In particular, from the viewpoint of reactivity with an unsaturated aliphatic group of the component (a), those having an average of three or more hydrogen atoms bonded to silicon atoms in one molecule are suitably used.

Specific examples of the component (b) include linear organopolysiloxane represented by the following Formula (3) and cyclic organopolysiloxane represented by the following Formula (4).

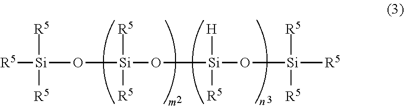

In Formula (3), m² represents an integer of 0 or more, n³ represents an integer of 3 or more, and R⁵ is each independently represents a monovalent unsubstituted or substituted hydrocarbon group that does not contain an unsaturated aliphatic group.

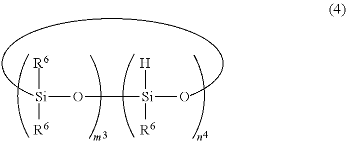

In Formula (4), m³ represents an integer of 0 or more, n⁴ represents an integer of 3 or more, and R⁶ is each independently represents a monovalent unsubstituted or substituted hydrocarbon group that does not contain an unsaturated aliphatic group.

Examples of the monovalent unsubstituted or substituted hydrocarbon group that does not contain an unsaturated aliphatic group and which can be represented by R⁵ and R⁶ in Formulas (3) and (4) include groups similar to R¹ in the above-described Formula (1). Among these, it is preferable that 50% or more of R⁵ and R⁶ be methyl groups, and it is more preferable that all of R⁵ and R⁶ be methyl groups, because synthesis and handling are easy and excellent heat resistance can be easily obtained.

### Component (c)

The catalyst used to form silicone rubber may be, for example, a hydrosilylation catalyst for promoting curing reactions. Known materials such as platinum compounds and rhodium compounds can be used as the hydrosilylation catalyst. The compounding amount of the catalyst can be set appropriately and is not particularly limited.

### Component (d)

Examples of the thermally conductive filler include metals, metal compounds, and carbon fibers. A highly thermally conductive filler is further preferable, and specific examples thereof include the following materials.

Silicon metal (Si), silicon carbide (SiC), silicon nitride (Si₃N₄), boron nitride (BN), aluminum nitride (AlN), alumina (Al₂O₃), zinc oxide (ZnO), magnesium oxide (MgO), silica (SiO₂), copper (Cu), aluminum (Al), silver (Ag), iron (Fe), nickel (Ni), vapor grown carbon fiber, PAN (polyacrylonitrile) carbon fiber, pitch-based carbon fiber.

These fillers can be used alone or in a mixed form of two or more types.

An average particle size of the filler is preferably from 1 μm to 50 μm from the viewpoint of handling and dispersibility.

Further, as the shape of the filler, a spherical shape, a pulverized shape, a needle shape, a plate shape, and a whiskers shape are used. In particular, from the viewpoint of dispersibility, a filler having a spherical shape is preferable. Further, at least one type selected from the group consisting of a reinforcing filler, a heat-resistant filler, and a coloring filler may be added.

### (7) Adhesive Layer

The rotating fixing member may include the adhesive layer 20f for bonding the surface layer 20d to be described later on the outer surface of the elastic layer 20c. The adhesive layer 20f is a layer for bonding the elastic layer 20c and the surface layer 20d together. The adhesive used for the adhesive layer 20f can be selected and used appropriately from known ones and is not particularly limited. However, from the viewpoint of ease of handling, it is preferable to use an addition curing silicone rubber containing a self-adhesive component.

The adhesive can contain, for example, a self-adhesive component, organopolysiloxane having a plurality of unsaturated aliphatic groups represented by vinyl groups in the molecular chain, hydrogenorganopolysiloxane, and a platinum compound as a crosslinking catalyst. The adhesive applied to the surface of the elastic layer 20c can be cured by an addition reaction to form the adhesive layer 20f for bonding the surface layer 20d to the elastic layer 20c.

The self-adhesive component may be, for example, the following components.

Silane having at least one type, preferably two or more types, of functional groups selected from the group consisting of an alkenyl group such as a vinyl group, a (meth)acryloxy group, a hydrosilyl group (SiH group), an epoxy group, an alkoxysilyl group, a carbonyl group, and a phenyl group.

An organosilicon compound such as a cyclic or linear siloxane having from 2 silicon atoms to 30 silicon atoms, and preferably from 4 silicon atoms to 20 silicon atoms.

Non-silicon-based organic compounds (that is, not containing silicon atoms in the molecule), which may contain oxygen atoms in the molecule. However, from one to four, preferably from one to two aromatic rings such as from a monovalent to tetravalent, preferably from a divalent to tetravalent, are contained in one molecule. At least one, preferably two or more and four or less, functional groups (for example, alkenyl groups, (meth) acryloxy groups) that can contribute to a hydrosilylation addition reaction are contained in one molecule.

The above-mentioned self-adhesive component may be used alone or in combination of two or more types. In addition, filler components may be added to the adhesive within the scope of the disclosure from the viewpoint of adjusting viscosity and ensuring heat resistance. Examples of the filler component include the following.

Silica, alumina, iron oxide, cerium oxide, cerium hydroxide, carbon black, and the like.

The compounding amount of each component contained in the adhesive is not particularly limited, and may be set appropriately. Such addition curing silicone rubber adhesives are also commercially available and readily available. The thickness of the adhesive layer 20f is preferably 20 μm or less. By setting the thickness of the adhesive layer 20f to 20 μm or less, when the fixing belt according to this embodiment is used as a heating belt in a thermal fixing device, thermal resistance can be easily set to be small, and heat from the inner surface side can be efficiently transferred to a recording medium.

### (8) Surface Layer

The rotating fixing member may include the surface layer 20d. It is preferable that the surface layer 20d contain a fluorine resin in order to exhibit a function as a release layer for preventing the adhesion of toner to the outer surface of the rotating fixing member. For the formation of the surface layer 20d, for example, a resin molded in a tube shape and exemplified below may be used, or the surface layer 20d may be formed by coating a resin dispersion.
Tetrafluoroethylene-perfluoro(alkylvinyl ether) copolymers (PFAs), polytetrafluoroethylene (PTFE), tetrafluoroethylene-hexafluoropropylene copolymers (FEPs), and the like.

Among the resin materials exemplified above, PFA is particularly suitably used from the viewpoint of moldability and toner releasability.

The thickness of the surface layer 20d is preferably from 10 μm to 50 μm. By setting the thickness of the surface layer 20d within this range, appropriate surface hardness of the rotating fixing member can be easily maintained.

As described above, according to one aspect of the present disclosure, a fixing device in which a rotating fixing member is disposed is provided. Thus, it is possible to provide the fixing device in which the rotating fixing member having high conductivity and excellent durability is disposed. The present disclosure also provides a conductive member including a base material and a heat generating layer on the base material. The base material and the heat generating layer are as described above. Such a conductive member can curb an increase in resistance at a high temperature.

In the conductive member, it is preferable that silver sulfide is present at a surface opposite to the side facing the base material side, that is, on the outer surface of the heat generating layer. It is also preferable that the silver sulfide layer is provided on the surface opposite to another surface of the heat generating layer facing the base material side.

In the conductive member, it is also preferable that silver sulfide is present inside the heat generating layer.

### EXAMPLE

In the following, the present disclosure will be specifically explained by using Examples. Note that the present disclosure is not limited to the following Examples.

### Example 1

The surface of a cylindrical stainless steel mold with an outer diameter of 30 mm was subjected to a mold release treatment and a commercially available polyimide precursor solution (U-Vanish S, manufactured by UBE Corporation) was applied by an immersion method to form a coating film. Next, this coating film was dried at 140° C. for 30 minutes to volatilize the solvent in the coating film, and then baked at 200° C. for 30 minutes and 400° C. for 30 minutes to imidize the coating film, forming a base material of a polyimide-coated film with a film thickness of 40 μm and a length of 300 mm.

Next, a ring-shaped pattern with a width of 600 μm and intervals of 200 μm was formed on the polyimide-coated film using an ink containing silver nanoparticles (DNS1691, manufactured by Daicel Corporation) by an inkjet method. Then, it was baked at 300° C. for 30 minutes to form the heat generating layer 20b with a film thickness of 3 μm.

Next, a silver sulfide layer was formed on the surface of the heat generating layer by the following method.

A lime-sulfur mixture solution (containing 27.5 mass % of calcium polysulfide, manufactured by Miyauchi Iou Gozai Co., Ltd) was prepared and diluted 2750 times with a 0.01 M NaOH aqueous solution (calcium polysulfide 0.01 mass % (sulfide ion concentration 0.008 mass %)) to obtain a sulfide solution. The sulfide solution was infiltrated into a urethane sponge, and the surface of the heat generating layer was traced. After tracing evenly, an excess sulfide solution was washed away with purified water, and the remaining moisture was removed by air blowing to form a silver sulfide layer.

Then, the entire surface of the heat generating layer 20b was ring-coated with a PAI solution (VYROMAX HR-16NN, manufactured by Toyobo Co., Ltd.). It was baked at 250° C. for 60 minutes to form the protective layer 20e (resin layer) having a thickness of 50 μm.

Next, a primer (trade name: DY39-051A/B, manufactured by Dow Toray Co., Ltd.) was applied substantially uniformly to the outer peripheral surface of the protective layer 20e so that a dry weight is 40 mg, the solvent was dried, and then a baking treatment was performed for 30 minutes in an electric furnace set at 160° C.

A silicone rubber composition layer having a thickness of 250 μm was formed on this primer by a ring coating method, and primary crosslinking was performed at 160° C. for 1 minute, and secondary crosslinking was performed at 200° C. for 30 minutes to form the elastic layer 20c.

Here, the following silicone rubber composition was used.

As the organopolysiloxane having an alkenyl group as the component (a), vinylated polydimethylsiloxane having at least two vinyl groups in one molecule (trade name: DMS-V41, manufactured by Gelest Inc., a number average molecular weight of 68,000 (based on polystyrene), 0.04 mmol/g molar equivalent of a vinyl group) was prepared.

In addition, as the organopolysiloxane containing an Si—H group as the component (b), methylhydrogenpolysiloxane having at least two Si—H groups in one molecule (trade name: HMS-301, manufactured by Gelest Inc., a number average molecular weight 1,300 (based on polystyrene), 3.60 mmol/g molar equivalent of a Si—H group) was prepared. 0.5 parts by mass of the component (b) was added to 100 parts by mass of the component (a) and sufficiently mixed to obtain an addition curing silicone rubber stock solution.

Furthermore, a catalytic amount of an addition curing reaction catalyst (platinum catalyst:platinum carbonylcyclovinylmethylsiloxane complex) and an inhibitor were added as the component (c) and mixed sufficiently. High-purity spherical alumina (trade name: Alnabeads CB-A 10S; manufactured by Showa Titanium Co., Ltd.) was mixed as a heat-conductive filler of the component (d) with the addition curing silicone rubber stock solution at a volume ratio of 45% based on the elastic layer, and kneaded. A n addition curing silicone rubber composition was then obtained with a JIS K 6253A durometer hardness of 100 after curing.

Next, an addition curing silicone rubber adhesive (trade name: SE1819CV A/B, manufactured by Dow Toray Co., Ltd.) for forming the adhesive layer 20f was substantially uniformly applied onto the obtained elastic layer 20c to a thickness of approximately 20 μm. A fluororesin tube (trade name: NSE, manufactured by Gunze Limited) with an inner diameter of 29 mm and a thickness of 30 μm for forming the surface layer 20d was stacked while expanding its diameter.

Thereafter, by uniformly pressing a belt surface from above the fluororesin tube, an excess adhesive was pressed out from between the elastic layer 20c and the fluororesin tube to become thin to approximately 5 μm. Next, the adhesive was cured by heating at 200° C. for 30 minutes, the fluororesin tube was fixed onto the elastic layer 20c, and finally, both ends thereof were cut to a length of 240 mm to obtain a rotating fixing member.

The number average crystal grain size of silver in the obtained heat generating layer was 182 nm, and the porosity was 22 area %.

### Example 2

A rotating fixing member was prepared in the same manner as in Example 1 except that the concentration of the calcium polysulfide was set to 0.05 mass % (the concentration of sulfide ions was 0.04 mass %). The number average crystal grain size of silver in the heat generating layer was 243 nm, and the porosity was 19 area %.

### Example 3

A rotating fixing member was prepared in the same manner as in Example 1 except that the concentration of the calcium polysulfide was set to 1.00 mass % (the concentration of sulfide ions was 0.8 mass %). The number average crystal grain size of silver in the heat generating layer was 339 nm, and the porosity was 15 area %.

### Example 4

Example 4 is an example related to a conductive member. The conductive member was manufactured in the same manner as in Example 2 except that a protective layer and the subsequent layers were not formed. The number average crystal grain size of silver in the heat generating layer was 211 nm, and the porosity was 20 area %.

### Example 5

A rotating fixing member was prepared in the same manner as in Example 1 except that the concentration of the calcium polysulfide was set to 0.002 mass % (the concentration of sulfide ions was 0.0016 mass %). The number average crystal grain size of silver in the heat generating layer was 160 nm, and the porosity was 23 area %.

### Comparative Example 1

A rotating fixing member was prepared in the same manner as in Example 1 except that a silver sulfide layer was not formed in the treatment of the heat generating layer.

Evaluation: Evaluation of Content of Silver Sulfide at the Surface of the Heat Generating Layer

It was confirmed whether the heat generating layer contains silver sulfide at the surface thereof by confirming the presence of the sulfur element using the following method. In Examples 1 to 5, sulfur peaks were confirmed at the surface of the heat generating layer (the surface on the protective layer side) opposite to another surface of the heat generating layer facing the base material, but they were not observed in Comparative Example 1.

First, an evaluation sample was prepared. A resin layer such as a protective layer formed on the surface of the heat generating layer was removed by a cutter to obtain a sample having the heat generating layer 20b formed on the base material. The sample was cut into 10 mm long and 10 mm wide. The cut-out sample was placed on a sample table called a platen for X-ray Photoelectron Spectroscopy and placed into an X-ray photoelectron spectrometer in ultrahigh vacuum. The X-ray photoelectron spectrometer performs measurement in an environment of 23° C.

The X-ray photoelectron spectrometer used was PHI Qunatera II manufactured by ULVAC-PHI, Inc. An AlKα X-ray source was used, and depth direction analysis was performed also using Ar sputtering. X-ray irradiation conditions were 200 μm, 50 W, and 15 kV, and detector conditions were pass energy of 112 eV and time per step of 10 ms. The Ar sputtering was performed under a condition that an acceleration voltage is 4 kV to process an area of 2 mm×2 mm. A processing rate was 37.5 nm/min. The heat generating layer with a known film thickness was excavated under the same conditions, and when the proportion of silver in the measured elements reached 50%, it was determined that the film was removed, and the processing rate was calculated from the time required.

The measured elements were C, N, O, Si, Ag, and S. Trajectories and measured energy ranges of the measured elements were as follows. 278 to 298 eV of C1s was measured for C, 391 to 411 eV of N1s was measured for N, 523 to 543 eV of O1s was measured for 0, 94 to 114 eV of Si2p was measured for Si, 362 to 382 eV of Ag3d was measured for Ag, and 154 to 176 eV of S2p was measured for S. The number of times measurement was repeated is 10 times for C1s, 10 times for N1s, 10 times for O1s, 10 times for Si2p, 10 times for Ag3d, and 40 times for S2p.

The depth direction measurement was repeated 10 times by performing Ar sputtering for 10 minutes after the surface of the heat generating layer was measured under the above-described processing conditions. Since the processing rate was 37.5 nm/min, analysis was performed at 375 nm pitch in the depth direction.

The resulting depth-direction spectrum was analyzed using MultiPak which is analysis software manufactured by UlVAC-PHI Inc. First, peak shift correction was performed on all spectra obtained. The method is as follows.

The top of the highest intensity peak that can be confirmed around 368 eV in a 3d spectrum of Ag was set to Ag3d5/2, and the energy was set to 368.3 eV. This value was obtained by referring to X-ray photoelectron spectroscopy (sixth publication by Maruzen Co., Ltd.).

Next, for each measurement spectrum, a background range was determined, and each intensity was obtained by calculating an integrated intensity and dividing it by a device-specific sensitivity coefficient (Corrected RSF). Background settings were made using the Shirley method. Elements and trajectories using the background setting ranges and a sensitivity factor specific to the device are as follows.

C is C1s at 280.0 to 292.0 eV, N is N1s at 396.5 to 404.0 eV, O is O1s at 526.0 to 538.0 eV, Si is Si2p at 99.7 to 108.0 eV, Ag is Ag3d at 364.0 to 380.0 eV, and S is S2p at 166.0 to 171.0 eV. For the sake of analysis, when the ranges did not match exactly, a deviation of ±0.1 eV was allowed.

Each of the calculated intensities was divided by the measured intensity of the element, and the percentage was taken as an element ratio. The ratio is at %, that is, atomic percentage. An S ratio is shown as an example.

$$S ratio ( at \% ) = ( S intensity ) / ( C intensity + N intensity + O intensity + Si intensity + Ag intensity + S intensity ) \times 100$$

Since the lower limit of detection of the X-ray photoelectron spectroscopy was 0.1 at % and described in the above-mentioned X-ray photoelectron spectroscopy (sixth publication), it was determined that an S element was present when S reached 0.1 at % or more in the above calculation method. As a result, in Examples 1 to 5, 0.2 to 7 at % of the S element was confirmed within a depth of 1 μm from the surface of the heat generating layer (the surface on the protective layer side) opposite to another surface of the heat generating layer facing the base material, whereas no S element was confirmed in Comparative Example 1.

### Evaluation: High Temperature Test

The rotating fixing members obtained in Examples 1 to 7 and Comparative Example 1 were stored under atmospheric pressure at 240° C. for 200 hours. This storage temperature was set from an overheating temperature assumed in the paper non-passing portion under a special use environment (in the case of continuous printing of small-size paper) when the rotating fixing member was actually incorporated into a fixing unit and used.

### Evaluation: Resistance Value Measurement

Resistance evaluation was performed using contact resistance measurement. The manufactured rotating fixing member was cut into half, one was used for initial resistance evaluation, and the other was used for evaluation after heating. When measuring resistance, the resin layer portion was peeled off using a cutter, and measurement was performed by a four-terminal resistance measurement method. The resistance measurement will be described in detail below.

Resistance measurements were performed using a resistance meter 3541 manufactured by HIOKI E.E. Corporation, and two FPC-GS-500 probes manufactured by Form Factor, Inc. The mode was set to a low power mode, and a resistance value was measured by pressing the probes against the heat generating layer so that a distance between the respective sense probes was 20 mm. The measured value was converted into a volume resistivity using the width and film thickness of the heat generating layer.

Similar measurements were performed before and after heating, and a fluctuation in volume resistivity value from an initial value was evaluated with the value before heating as the initial value. A fluctuation of less than ±5% was evaluated as A, a fluctuation of ±5% or more and less than ±10% was evaluated as B, and a fluctuation of ±10% or more was evaluated as C.

TABLE 1

| | | Heat generating layer | | | | | | | Evaluation |
|---|---|---|---|---|---|---|---|---|---|
| | | | | | | Average | | | Resistance |
| | | | | Concentration | | crystal | | | fluctuation |
| | Base | | | of sulfide | | grain | | Resin | rate at 240° |
| | material | Metal | Thickness | solution | Silver sulfide | size | Porosity | layer | C. for 200 h |
| | Type | species | μm | Mass % | layer | nm | % | Type | % |
| Example 1 | PI | Ag | 3 | 0.01 | Included | 182 | 22 | PAI | +3 |
| | | | | | | | | | A |
| Example 2 | PI | Ag | 3 | 0.05 | Included | 243 | 19 | PAI | −3 |
| | | | | | | | | | A |
| Example 3 | PI | Ag | 3 | 1.00 | Included | 339 | 15 | PAI | −4 |
| | | | | | | | | | A |
| Example 4 | PI | Ag | 3 | 0.05 | Included | 211 | 20 | — | −2 |
| | | | | | | | | | A |
| Example 5 | PI | Ag | 3 | 0.002 | Included | 160 | 23 | PAI | +6 |
| | | | | | | | | | B |
| Comparative | PI | Ag | 3 | — | Not included | 143 | 26 | PAI | +20 |
| Example 1 | | | | | | | | | C |

From the results in Table 1, the presence of silver sulfide at the surface of the heat generating layer can curb an increase in resistance due to heating at 240° C. and curb the occurrence of image defects.

### Example 6

Next, silver sulfide is formed at the surface of the heat generating layer or the inside of the heat generating layer.

A lime-sulfur mixture solution (containing 27.5 mass % of calcium polysulfide, manufactured by Miyauchi Iou Gozai Co., Ltd) was prepared and diluted 9.17 times with a 0.01 M NaOH aqueous solution (calcium polysulfide 3.00 mass % (sulfide ion concentration 2.40 mass %)) to obtain a sulfide solution. The sulfide solution was added to an ink containing silver nanoparticles (DNS1691, manufactured by Daicel Corporation). The blending ratio was that sulfide solution:ink containing silver nanoparticles=1:66.7 by mass. After addition, a liquid containing sulfide ions and silver nanoparticles was obtained by stirring at 2000 rpm for 2 minutes with a self-rotating agitator.

A ring-shaped pattern with a width of 600 μm and intervals of 200 μm was formed on the polyimide-coated film using the obtained liquid containing sulfide ions and silver nanoparticles by an inkjet method. Then, it was baked at 300° C. for 30 minutes to form the heat generating layer 20b with a film thickness of 3 μm.

A rotating fixing member was prepared in the same manner as in Example 1 except for the above described. The number average crystal grain size of silver in the heat generating layer was 180 nm, and the porosity was 22 area %.

### Example 7

A rotating fixing member was prepared in the same manner as in Example 6 except that the concentration of the calcium polysulfide was set to 1.50 mass % (the concentration of sulfide ions was 1.20 mass %). The number average crystal grain size of silver in the heat generating layer was 154 nm, and the porosity was 24 area %.

Evaluation: Evaluation of Content of Silver Sulfide Inside the Heat Generating Layer

The “inside” of the heat generating layer was defined as the area deeper than 1 μm in depth from the outermost surface of the heat generating layer on the side opposite to the side facing the substrate.

It was confirmed whether the heat generating layer contains silver sulfide inside thereof by confirming the presence of the sulfur element using the following method. In Examples 6 and 7, the presence of sulfur was confirmed inside the heat generating layer.

The amount of the sulfur was calculated by the following method.

First, an evaluation sample was prepared. One sample having a length of 5 mm, a width of 5 mm and a thickness equal to the total thickness of the rotating fixing member was collected from the central portion of the rotating fixing member in the rotation axis direction. For the obtained sample, the cross-section of the rotating fixing member in the circumferential direction was polished by using an ion beam. At this time, a machining position was adjusted so that the cross-section of the heat generating layer in the circumferential direction was exposed by polishing using the ion beam.

An ion milling device (trade name: IM4000, manufactured by Hitachi High-Tech Corporation) was used to polish the cross-section using the ion beam. In the polishing of the cross-section using the ion beam, falling of a filler from the sample and mixing of an abrasive can be prevented, and the cross-section with less polishing marks can be formed. Subsequently, the cross-section of the heat generating layer was observed with a scanning electron microscope (SEM) (trade name: JSM-F100, manufactured by JEOL Ltd.) to obtain a cross-sectional image and an energy dispersive X-ray spectroscopy (EDS) image. The observation conditions were field of view: 4.2 μm×3.2 μm, acceleration voltage: 5.0 kV, and working distance: 10 mm. EDS spectra were also acquired under the condition that the acceleration voltage was changed to 10.0 kV. The spatial range for EDS analysis was field of view: 4.2 μm×3.2 μm, and the position was adjusted to select only the heat generating layer portion in the observed image.

Five images were obtained for one sample, and EDS analysis was performed for the five images. The at % of sulfur was determined from the percentage of elements obtained by EDS analysis, and the average value was calculated from the analysis results of the at % of sulfur for the five images and used as the sulfur content.

The lower limit of detection for EDS analysis was set at 0.1 at %. Therefore, it was determined that an S element was present when S reached 0.1 at % or more, that is, silver sulfide was present inside the heat generating layer. As a result, in Examples 6 and 7, it was confirmed that 0.2 to 0.4 at % of the S element was present inside the heat generating layer.

TABLE 2

| | | Heat generating layer | | | | | | | | | | Evaluation |
|---|---|---|---|---|---|---|---|---|---|---|---|---|
| | | | | | Surface of the heat | | Inside the heat | | Average | | | Resistance |
| | | | | Concentration | generating layer | | generating layer | | crystal | | | fluctuation |
| | Base | | | of sulfide | | Amount of | | Amount of | grain | | Resin | rate at 240° |
| | material | Metal | Thickness | solution | Silver | S element | Silver | S element | size | Porosity | layer | C. for 200 h |
| | Type | species | μm | Mass % | sulfide | at % | sulfide | at % | nm | % | Type | % |
| Example 6 | PI | Ag | 3 | 3.00 | Included | 0.3 | Included | 0.4 | 180 | 22 | PAI | +1 |
| | | | | | | | | | | | | A |
| Example 7 | PI | Ag | 3 | 1.50 | Included | 0.2 | Included | 0.2 | 154 | 24 | PAI | +10 |
| | | | | | | | | | | | | B |

From the results in Table 2, the presence of silver sulfide inside the heat generating layer can curb an increase in resistance due to heating at 240° C. and curb the occurrence of image defects.

As described above, according to the present disclosure, it is possible to obtain a rotating fixing member that is excellent in durability even in a special environment where small-sized paper is continuously printed.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-070378, filed Apr. 24, 2024, and Japanese Patent Application No. 2025-025262, filed Feb. 19, 2025, all of which are hereby incorporated by reference herein in their entirety.

What is claimed is:

1. A rotating fixing member, comprising:
a base material containing a resin;
a heat generating layer on the base material; and
a resin layer on a surface of the heat generating layer opposite to another surface of the heat generating layer facing the base material,
wherein the heat generating layer extends in a circumferential direction of an outer peripheral surface of the base material,
wherein the heat generating layer contains silver, and
wherein at least one of the following conditions (A) and (B) is satisfied,
(A): silver sulfide is present at the surface of the heat generating layer opposite to the another surface facing the base material,
(B): silver sulfide is present inside of the heat generating layer.

2. The rotating fixing member according to claim 1, wherein both of the conditions (A) and (B) are satisfied.

3. The rotating fixing member according to claim 1, wherein a number average crystal grain size of the silver contained in the heat generating layer is 500 nm or less.

4. The rotating fixing member according to claim 1, wherein silver sulfide is present at grain boundaries of silver crystals contained in the heat generating layer.

5. The rotating fixing member according to claim 1, wherein the heat generating layer has a pore in a cross-sectional view in a circumferential direction thereof, and silver sulfide is present on an inner wall of the pore.

6. The rotating fixing member according to claim 5, wherein a proportion of the pore in a cross-section of the heat generating layer, which is measured by observing a cross-section obtained by cutting the heat generating layer sampled from the rotating fixing member in a thickness direction, is 13 to 50 area %.

7. The rotating fixing member according to claim 1, wherein a thickness of the heat generating layer is 5 μm or less.

8. The rotating fixing member according to claim 1, wherein the heat generating layer has a plurality of segments arranged in a longitudinal direction of the rotating fixing member and electrically separated from each other, and each of the plurality of segments are continuously formed over an entire region of the rotating fixing member in the circumferential direction.

9. The rotating fixing member according to claim 1, wherein the heat generating layer includes a silver sulfide layer on the surface of the heat generating layer opposite to the another surface of the heat generating layer facing the base material.

10. A fixing device comprising:
the rotating fixing member according to claim 1; and
an induction heating device that causes the rotating fixing member to generate heat by induction heating.

11. An electrophotographic image forming apparatus comprising:
an image carrier that carries a toner image;
a transfer device that transfers the toner image to a recording material; and
a fixing device that fixes the transferred toner image to the recording material, wherein
the fixing device is the fixing device according to claim 10.

12. A method of manufacturing the rotating fixing member according to claim 1, the method is selected from the group consisting of method (i) and (ii):
the method (i) comprising:
preparing a stacked body in which the heat generating layer is formed on the base material;
infiltrating a sulfide solution containing sulfide ions from the surface of the heat generating layer opposite to the another surface facing the base material; and
removing the excess sulfide solution after the sulfide solution is infiltrated;
the method (ii) comprising:
coating a liquid containing sulfide ions and silver nanoparticles on the base material; and
forming the heat generating layer by baking the coated liquid.

13. A conductive member comprising:
a base material; and
a heat generating layer on the base material,
wherein the heat generating layer contains silver, and
wherein at least one of the following conditions (A) and (B) is satisfied,
(A): silver sulfide is present at a surface of the heat generating layer opposite to another surface of the heat generating layer facing the base material,
(B): silver sulfide is present inside of the heat generating layer.
